(19) United States
(12) Patent Application Publication
(10) Pub. No.: US 2016/0182498 A1
(43) Pub. Date: Jun. 23, 2016

(54) SEPARATED USE MOBILE DEVICES

(71) Applicant: EBAY INC., San Jose, CA (US)

(72) Inventor: Randall Joseph Straka, Omaha, NE (US)

(21) Appl. No.: 14/576,102

(22) Filed: Dec. 18, 2014

(51) Int. Cl. H04L 29/06; G06F 12/14; G06F 3/06

(52) U.S. Cl. CPC H04L 63/0853; G06F 3/0689; G06F 3/0619; G06F 3/0665; G06F 12/1458

(57) ABSTRACT

Separated use mobile devices may be provided having multiple memories associated respectively with multiple operating environments that are managed by a common operating system. When the mobile device is operating in a first operating environment, access to a second storage may be prevented. When the mobile device is operating in a second operating environment, access to a first storage may be prevented. The first operating environment may be a personal operating environment for a user and may have associated personal applications and data. The second operating environment may be a work operating environment for the same user and may have associated work applications and data. The split mobile device may have a notification managing engine that selectively provides notifications associated with each operating environment to the user while the mobile device is being operated in any operating environment.

### TECHNICAL FIELD

The present invention generally relates to electronic devices and, more particularly, to separated use mobile devices.

### BACKGROUND

Modern users of electronic devices such as mobile devices often use their devices for both personal and work-related activities. In many cases, it can be inconvenient or even illegal for work and person information to be merged. Many users therefore carry multiple devices. For example, many users carry one mobile device for personal use and another for work use. Other users use a single device for both work and personal use, thereby risking confusion between personal and work emails, contacts, and/or schedules and risking exposing sensitive personal or business information to an unintended party. It would therefore be desirable to be able to provide improved mobile devices.

### BRIEF DESCRIPTION OF THE DRAWINGS

FIG. 1 is a block diagram of an illustrative networked system including a separated or split use mobile device, according to an embodiment.

FIG. 2 is a block diagram of an illustrative split user device, according to an embodiment.

FIG. 3 is a block diagram of an illustrative split user device showing how a user may switch between a personal portion of the split user device and a work portion of the split user device, according to an embodiment.

FIG. 4 is block diagram of an illustrative split user device showing how personal applications and common applications may be provided on a personal portion of a split user device, according to an embodiment.

FIG. 5 is a diagram of a portion of a split user device with multiple network capabilities, according to an embodiment.

FIG. 6 is a diagram of a portion of a split user device having an add-on device providing multiple network capabilities, according to an embodiment.

FIG. 7 is a flowchart of an exemplary process for operating a split user device, according to an embodiment.

FIG. 8 is a flowchart of an exemplary process for providing notifications to a user with a split user device, according to an embodiment.

FIG. 9 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Separated use user devices may be provided having multiple operating environments, each having a separate associated storage, and each managed by a common operating system. The multiple operating environments may include a personal operating environment and a work operating environment. Data associated with the personal operating environment may be stored in a personal database in the split user device. Data associated with the work operating environment may be stored in a work database in the separated use user device (sometimes referred to herein as a split user device or split mobile device). The personal database may be inaccessible to the work operating environment. The work database may be inaccessible to the personal operating environment.

A notification manager may be provided that manages work and personal notifications for the user that originate from either or both of the personal and work operating environments. In this way, personal and work activities may be performed with a single user device without risking unwanted mixing or exposure of information while maintaining the ability of the user to receive personal and/or work notifications at all times. In some embodiments, the split user device may be in switchable communication with multiple networks such as a personal network and a work network based on the current operating environment.

According to an embodiment, a mobile device is provided that includes a first operating environment having a first application; a first storage; a second operating environment having a second application; a second storage; and an operating system configured to switchably operate the device in the first operating environment or the second operating environment, where the first application is configured to read and write data respectively from and to the first storage, wherein the second application is configured to read and write data respectively from and to the second storage, wherein the first application is prevented from reading and writing data respectively from and to the second storage, and wherein the second application is prevented from reading and writing data respectively from and to the first storage.

According to another embodiment, a method of operating a split mobile device having a display, a first storage, and a second storage is provided that includes providing, with an operating system using the first storage, a first operating environment to a user; while providing the first operating environment to the user, preventing access to the second storage; receiving, with the operating system, a request from the user to operate the mobile device in a second operating environment; providing, with the operating system using the second storage, the second operating environment to the user responsive to the receiving; and, while providing the second operating environment to the user, preventing access to the first storage.

According to another embodiment, a multiple subscriber identity module device is provided that includes a first SIM port configured to receive a first SIM card of a first network; a second SIM port configured to receive a second SIM card of a second network; and a coupling mechanism configured to couple the first SIM card and the second SIM card to a SIM port of a mobile device such as a split mobile device.

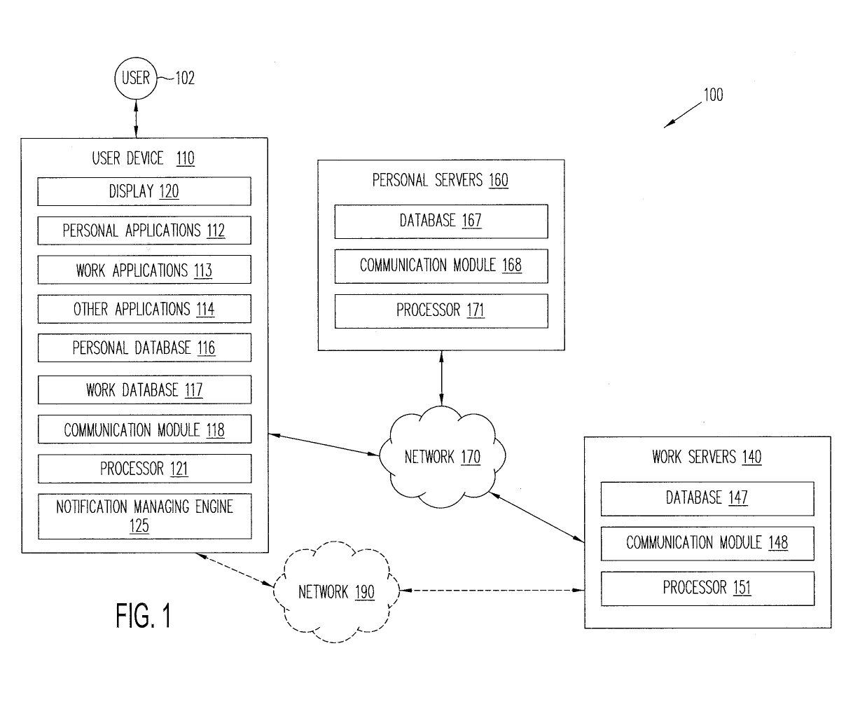

FIG. 1 is a block diagram of a networked system 100 suitable for operating a split user device, according to an embodiment. As shown, system 100 may comprise or implement a plurality of devices, servers, and/or processors, databases, and/or other components arranged to perform various methodologies in accordance with the described embodiments. Exemplary devices and servers may include devices, stand-alone, and enterprise-class servers, operating an operating system (OS) such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 may include one or more user devices such as user device 110 and one or more servers such as personal servers 160 and work servers 140 in communication over a network 170. A user 102 may utilize their corresponding user device 110 to communicate with personal server 160 and/or work servers 140. User device 110 may be a split user device having multiple operating environments, each having a separate associated storage, that are managed by the same operating system

User devices 110, and servers 140 and 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over a network such as network 170.

Personal servers 160 may include, for example, servers such as email servers, interne service provider servers, social networking servers, content provider servers for content such as music content, video content, or other entertainment content, financial services severs such as payment provider servers, and/or other servers suitable for performing operations related to a user's home or personal activities. Personal servers 160 may include computing equipment such as a database 167, a communication module 168, and a processor 171 that are arranged to cooperate to perform various functions described herein. Work servers 140 may include, for example, servers such as email servers, Internet service provider servers, database servers, encryption servers, document processing servers, financial services servers such as payment provider servers, and/or other servers suitable for performing operations related to a work or business activities. Work servers 140 may include computing equipment such as a database 147, a communication module 148, and a processor 151 that are arranged to cooperate to perform various functions described herein.

As shown in FIG. 1, system 100 may optionally include an additional network 190. Network 190 may be a wide area network such as a cellular communications network and/or a relatively local area network such as a wireless local area network (WLAN) of a business or company. In some embodiments, user device 110 may communicate with both personal servers 160 and work servers 140 via network 170. In other embodiments, user device 110 (e.g., while in a work operating environment of user device 110) may communicate with work servers 140 via a separate network such as network 190. In this way, network and data communications between user device 110, for various purposes, can be performed using separate and independent networks or a common network. For example, a user may subscribe to a first cellular network for personal use and may subscribe or be provided with a subscription to a second cellular network for work use. User device 110 may communicate with a single network using communications circuitry, with multiple networks using common communications circuitry, or multiple networks using separate corresponding communications circuitry. For example, a work operating environment and a personal operating environment may access a common network using a single subscriber identity module (SIM) card or a work operating environment a work operating environment may access a work network using a work subscriber identity module (SIM) card and a personal operating environment may access a personal network using a person subscriber identity module (SIM) card. In an embodiment in which user device 110 is provided with communications circuitry capable of communicating with both networks, the business data can be communicated without affecting the user's personal network subscription and vice versa. Networks 170 and 190 may be networks of a common network service provider or may be networks of different and unrelated network service providers.

Each user device 110 may be implemented using hardware including hardware configured for wired and/or wireless communication with servers 140 and 160. For example, in one embodiment, user device 110 may be implemented as a personal computer (PC), a smart phone, personal digital assistant (PDA), laptop computer, a wristwatch with appropriate computer hardware resources, eyeglasses with appropriate computer hardware (e.g. GOOGLE GLASS®) and/or other types of computing devices such as mobile devices capable of transmitting and/or receiving data, such as an IPHONE® or IPAD® from APPLE® (as examples).

As shown in FIG. 1, user device 110 may include a display 120, a personal database 116, a work database 117, one or more communication modules such as communication module 118, one or more processors such as processor 121, and various applications such as personal applications 112, work applications 113, and/or other applications 114. Communication module 118 may include communications circuitry such as one or more antennas and associated front-end circuitry such as near field communications circuitry, Bluetooth or Bluetooth Low Energy circuitry, a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, or other communications circuitry).

Display 120 may be a liquid crystal display, a light emitting diode display or other suitable display for presenting text, images, and/or other display content to user 102. Personal database 116 may include memory such as volatile or non-volatile memory for storing data associated with operations performed with a first operating environment such as a personal operating environment of user device 110. Work database 117 may include additional memory such as additional volatile or non-volatile memory for storing data associated with operations performed with a second operating environment such as a work operating environment of user device 110.

Personal applications 112 may include email applications; web browsing applications, gaming applications, word processing applications, document processing applications, device control applications, image processing applications, financial applications or other suitable applications for providing personal computing functionality for a user. Work applications 113 may include email applications, web browsing applications, word processing applications, document processing applications, device control applications, image processing applications, financial applications or other suitable applications for proving work or business computing functionality for a user.

For example, personal applications 112 may include a web browser, a game, a photo viewing application, a photo editing application, a social networking application and a banking application (as examples). Personal applications 112 may be stored on personal database 116 and may read and write data respectively from and to personal database 116. Personal applications 112 may be prevented from writing, reading, altering, or otherwise accessing data to or from work database 117. Work applications 113 may include a web browser, an image editing application, a work processing application, a spreadsheet application, a compiler, an email application, or a file sharing application (as examples). Work applications 113 may be stored on work database 117 and may read and write data respectively from and to work database 117. Work applications 113 may be prevented from writing, reading, altering, or otherwise accessing data to or from personal database 116.

One or more processors such as processor 121 may be provided in user device 110 for executing instructions stored on work database 117 and/or personal database 116 and for writing and reading data to and from work database 117 and/or personal database 116.

Because a user may desire to receive notifications associated with work (e.g., meeting reminders or deadline alerts) and home (e.g., birthday reminders or other personal scheduling reminders) regardless of which operating environment is functioning on the user device, user device 110 may be provided with a notification managing engine 125 capable of providing notifications associated with either operating environment to the user. Notification managing engine 125 may receive notifications from more than one operating environment and may sort, block, and/or provide the notifications to the user based on the current operating environment and one or more notification settings.

For example, while the device is being operated in a first operating environment, all notifications for that operating environment may be provided to the user and some or all notifications from another operating environment may be provided based on the notification settings. For example, in a work operating environment, a user may be provided with all work-related notifications and only emergency personal notifications or personal notifications of a selected category or having an importance over a selected threshold may be provided (e.g., birthday reminders may be temporarily blocked and doctor appointments or emergency-related text messages may be provided). In another example, in a personal operating environment, a user may be provided with all home-related notifications and only emergency work notifications or work notifications of a selected category or having an importance over a selected threshold may be provided (e.g., recurring weekly meeting reminders may be suppressed and urgent customer email alerts may be provided). Notification settings may include default settings and/or user-provided settings for managing notifications.

Other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications. Other applications 114 may include browser and/or mapping applications. Other applications 114 may contain software programs, executable by a processor, including a graphical user interface (GUI) configured to provide an interface to the user. Other applications 114 may include common applications for multiple operating environments and/or applications that are restricted to a particular operating environment (e.g., other applications 114 can include some personal applications and some work applications).

Network 170 and/or network 190 may each be implemented as a single network or a combination of multiple networks. For example, in various embodiments, network 170 and/or network 190 may include the Internet or one or more intranets, landline networks, wireless networks, cellular networks, and/or other appropriate types of networks. Thus, network 170 and/or network 190 may correspond to small scale communication networks, such as a private or local area network, or a larger scale network, such as a wide area network or the Internet, accessible by the various components of system 100.

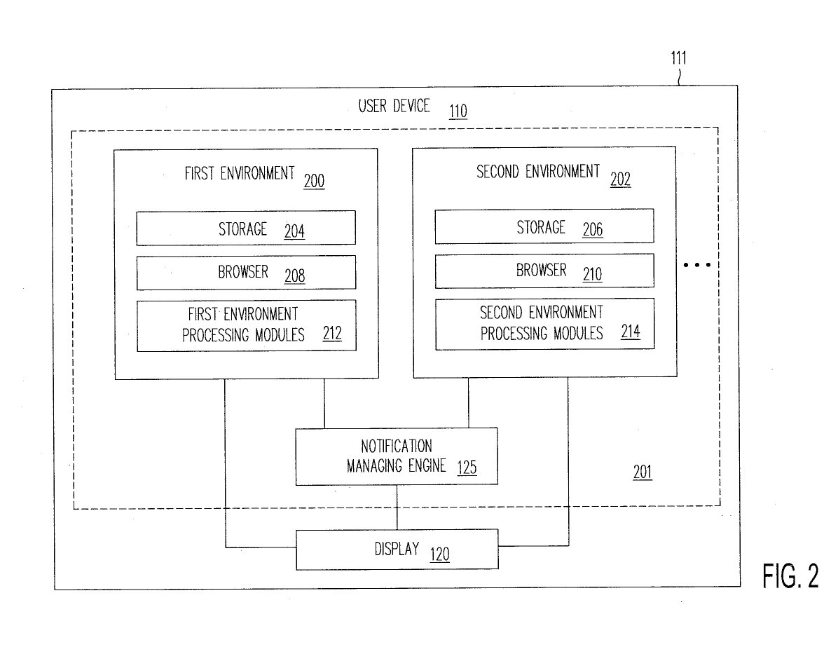

FIG. 2 is a block diagram showing how user device 110 of FIG. 1 may be arranged with multiple operating environments, each having separate storage, browsers, and processing modules and each in communication with a display and a notification managing engine. In the example of FIG. 2, user device 110 is a split user device having at least a first operating environment 200 and a second operating environment 202 that run on a common operating system 201 (e.g., a UNIX®, LINUX®, MICROSOFT®, ANDROID®, or other operating system).

As shown in FIG. 2, first operating environment 200 may be operated from a first storage 204 and may include associated first applications such as an associated first browser 208 and other associated first environment processing modules 212. Browser data such as cookies, downloaded files, and/or browser history information for browser 208 of first environment 200 may be stored using storage 204. Various other data acquired, generated, or received when operating user device with first environment 200 may also be stored using storage 204. Other data acquired, generated, or received when operating user device with first environment 200 may include images, videos, messages, word processing documents, spreadsheets, application files, equipment driver files, executable files, code libraries, or any other data. In one embodiment, first operating environment 200 is a home or personal operating environment and storage 204 is configured to receive and store home or personal data acquired, generated, or received while device 110 is operated using the common operating system and the first operating environment.

Second operating environment 202 may be operated from a second storage 206 and may include associated second applications such as an associated second browser 210 and other associated second environment processing modules 214. Browser data such as cookies, downloaded files, and/or browser history information for browser 210 of second environment 202 may be stored using storage 206. Various other data acquired, generated, or received when operating user device with second environment 202 may also be stored using storage 206. Other data acquired, generated, or received when operating user device 110 with second environment 202 may include images, videos, messages, word processing documents, spreadsheets, application files, equipment driver files, executable files, code libraries, or any other data. In one embodiment, second operating environment 202 is a work or business operating environment and storage 206 is configured to receive and store work or business data acquired, generated, or received while device 110 is operated using the common operating system and the second operating environment.

As discussed above, storage 204 and storage 206 may be physically distinct storage units. For example, storage 204 and storage 206 may each include one or more separate hard drives and/or random access memory banks. In general, storage 204 and storage 206 may be implemented using any suitable volatile and/or non-volatile memory. In one embodiment, storage 204 and storage 206 may be separate partitions of a common storage device. However, despite the physical arrangement of storage 204 and 206, browser 208 and first environment processing modules 212 may be prevented from accessing (e.g., reading data from or writing data to) storage 206. Similarly, browser 210 and second environment processing modules 214 may be prevented from accessing (e.g., reading data from or writing data to) storage 204.

Preventing applications of one operating environment from accessing the storage of another operating environment may include encrypting data associated with the applications of each environment using separate encryption keys that are stored on the respective storages. For example, each of browser 208 and first environment processing modules 212 may be programmed to include an encryption key or other passcode for writing and reading data from storage 204. Similarly, each of browser 210 and second environment processing modules 214 may be programmed to include an encryption key or other passcode for writing and reading data from storage 206. In various embodiments, each operating environment may include one or more dedicated processors and/or a common processor may be used to run processes for each environment. If desired, an additional storage may be provided for storing boot information and operating system information for the common operating system 201.

As shown in FIG. 2, display 120 may be configured to display content provided by either operating environment and/or notifications associated with either operating environment. Notification managing engine 125 may control which notifications are provided to display 120 for notification of the user based on, for example, which operating environment is being operated and user or default settings for notifications.

For example, while the device is being operated in first operating environment 200, notification managing engine 125 may provide all notifications for that operating environment and some or all notifications from second operating environment 202 based on the notification settings to display 120. For example, in a work operating environment, a user may be provided with all work-related notifications and only emergency personal notifications or notifications of a selected category or having an importance over a selected threshold may be provided by engine 125 (e.g., social media update notifications may be temporarily blocked by engine 125 and children's teacher meetings or emergency-related email messages may be provided to display 120). In another example, in a personal operating environment, a user may be provided with all home-related notifications and only emergency work notifications or notifications of a selected category or having an importance over a selected threshold may be provided by engine 125 to display 120 (e.g., work-related social event reminders may be suppressed and non-extendible client deadlines may be provided). Notification settings may include default settings and/or user-provided settings for managing notifications and may be stored on a storage component that accessible by notification managing engine 125 or may be stored by notification managing engine 125.

As shown in FIG. 2, the first and second storage, the display, the notification managing engine, as well and processing circuitry, memories, applications, and data for user device 110 may be formed within a common housing 111 (e.g., metal, plastic, glass, and/or other materials formed into one or more housing members that surround the noted components to form a single device such as portable or mobile device).

Because the separate operating environments are managed by a common operating system, a user may be provided with the ability to seamlessly switch between operating environments. For example, a switch icon (e.g., an icon representing another operating environment that, when tapped or clicked, causes the switch), a physical or virtual button, a physical or virtual switch, or other switching mechanism may be provided that, when operated by the user, causes a switch between operating environments.

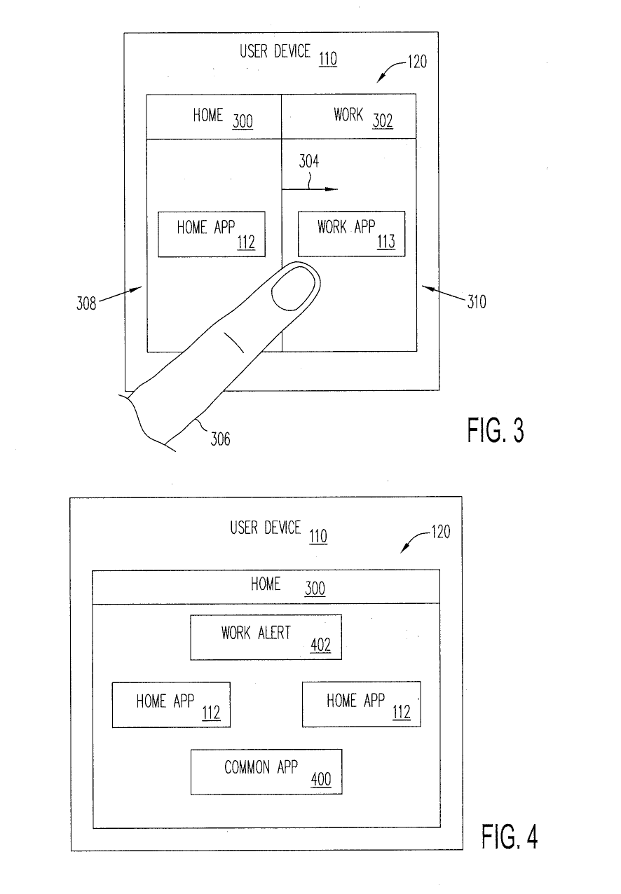

In one example, as shown in FIG. 3, the user may be provided with the ability to switch to a home operating environment 300 from a work operating environment 302 by swiping along a touchscreen display (e.g., with the user's finger 306 or another device as indicated by arrow 304). As shown in the embodiment of FIG. 3, as the user swipes, a portion 308 of display 120 may display a home screen or desktop of home operating environment 300 and a portion 310 of display 120 may display a home screen or desktop of work operating environment 302. However, this is merely illustrative. In various embodiments, any suitable switching mechanism may be provided for switching between operating environments. For example, the switching mechanism may be specific to an operating system so that the switching mechanism does not interfere with other operations of the device (e.g., in a device in which a finger swipe provides other functionality, an icon or virtual button may be provided for switching between operating environments). In various embodiments, the display 120 may display the transition from one operating environment to another operating environment, may display an intermediate screen such as a background image, a “Please Wait” icon or other similar icon, or the transition from one operating environment to another operating environment may happen virtually instantaneously so that the user cannot perceive the transition and is merely provided with a refreshed screen displaying the new operating environment.

The home screen or desktop of home operating environment 300 may show available applications 112 associated with the home operating environment 300 and the home screen or desktop of work operating environment 302 may show available applications 113 associated with the work operating environment. In this way, only the applications used in a particular operating environment are displayed when the device is operated in that operating environment.

In some scenarios home app 112 and work app 113 may be different implementations of the same application (e.g., a browser or an email client). However, home app 112 and work app 113 may each be prevented from writing, reading, or displaying data or other associated with the other of home app 112 and work app 113 whether they are implementations of the same or different applications. In one embodiment, when the user switches to home environment 300 from work environment 302, a storage component associated with work environment 302 may be deactivated to further prevent home environment 300 from accessing that storage, and vice versa.

FIG. 4 shows an example of user device 110 being operated in a first (home) operating environment 300. As shown in FIG. 4, in the home operating environment 300 one or more home applications 112 may be displayed for access by the user. In some embodiments, one or more common applications such as common app 400 may also be provided for access by the user. In these embodiments, when a user switches to, for example, a work operating environment, the common app 400 may remain displayed for access while the home apps 112 disappear from view so that they cannot be accessed in the work operating environment. FIG. 4 also shows how, while operating the user device in the home operating environment 300, a work notification such as work alert 402 may be provided to the user on the display 120.

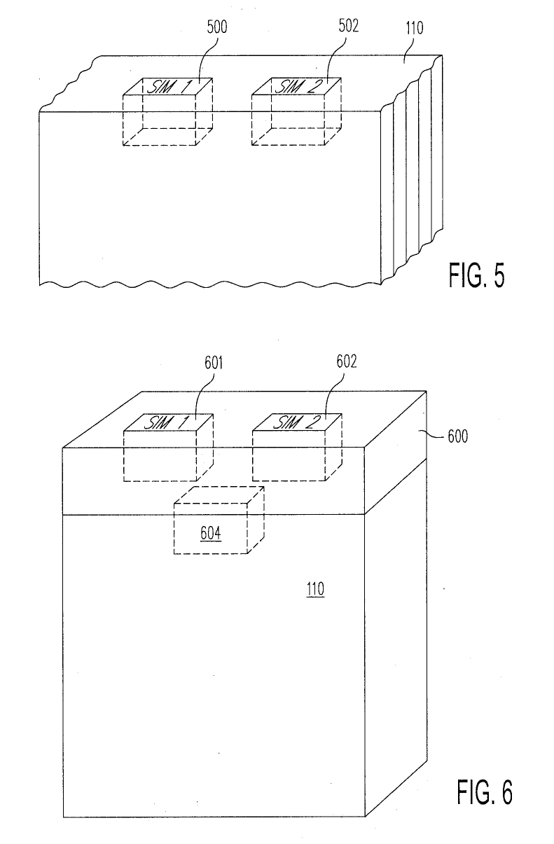

Because a user's work and home networks may be provided by different network service providers, user device 110 may be provided with communications circuitry for communicating with multiple networks including multiple cellular communications networks. Because different network service providers can each require a subscriber identity module (SIM) card that identifies the user as a subscriber to that network, user device 110 may be provided with multiple SIM card ports such as SIM card ports 500 and 502 of FIG. 5. First and second SIM cards such as SIM cards SIM1 and SIM2, each associated with a particular service provider network and a particular operating environment of user device 110 may be installed in ports 500 and 502.

For example SIM1 may be associated with a user's home cellular network and SIM2 may be associated with the user's work cellular network. When the user switches between a home and work operating environment, the associated SIM card may be used to facilitate communications with that associated network.

In some situations, multiple operating environments may be provided for user in a device having only a single SIM port. As shown in FIG. 6, an add-on device such as multiple subscriber identity module device 600 may be provided that couples multiple SIM ports such as SIM ports 601 and 602 to a single SIM port such as SIM port 604 of the user device. For example, device 600 may include a coupling mechanism such as protruding portion having a SIM card shape for inserting into SIM port 604 and suitable circuitry for coupling multiple SIM cards such as SIM1 and SIM2 in FIG. 6 to communications circuitry of the mobile device. In this way, multiple SIM cards such as SIM cards SIM1 and SIM2 may be communicatively coupled with multiple corresponding operating environments through a single common SIM port of the device. It should be appreciated that the embodiments of FIGS. 5 and 6 are merely illustrative and that in other embodiments, user device 110 may be provided with a single SIM port or no SIM port at all (e.g., for networks that do not require a SIM card) and that user device 110 may communicate, while operating in various operating environments, with a common network or with separate corresponding networks. In multiple network embodiments, user device 110 may communicate with the multiple networks using common communications circuitry (e.g., including a common SIM card and/or common internal communications circuitry) or using separate communications circuitry (e.g., using separate SIM cards each corresponding to a particular network and/or separate internal communications circuitry).

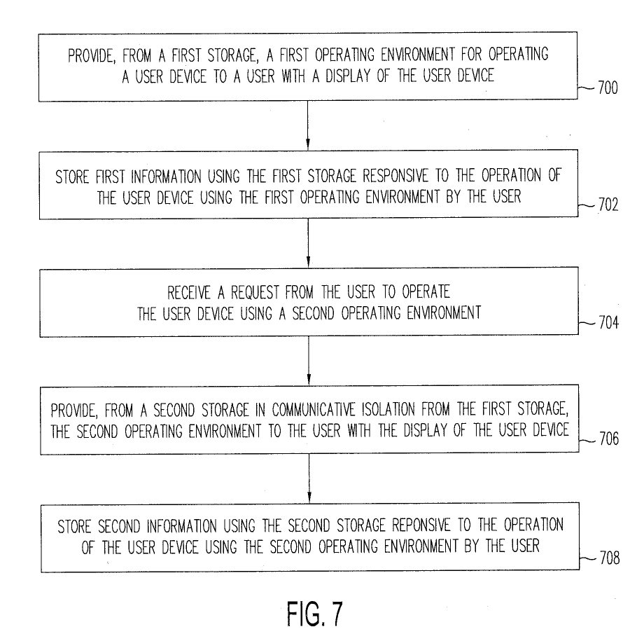

FIG. 7 is a flowchart of an exemplary process for operating a split user device, according to an embodiment.

At step 700, a first operating environment for operating a user device may be provided, from a first storage, to a user with a display of the user device. Providing the first operating environment may include, with an operating system of the device, executing first operating environment execution code stored on the first storage. Providing the first operating environment may include providing, on a home screen or desktop of the user device, first applications that, when executed, read and/or write data from and/or to the first storage.

At step 702, first information may be stored using the first storage responsive to the operation of the user device using the first operating environment by the user. Storing the first information may include operating a first application in the first operating environment, generating, receiving, or otherwise acquiring data with the first application, and storing the generated, received, and/or acquired data with the first storage. Some or all of the first information may, in some scenarios, be received via a first network (e.g., using a first SIM card) of the user device.

At step 704, a request may be received (e.g., by the operating system) from the user to operate the user device using a second operating environment. Receiving the request to operate the user device using the second operating environment may include detecting touchscreen input such as a swipe of the user's finger across the touchscreen, touchpad input, mouse input, and/or keyboard input to select the second operating environment.

At step 706, the second operating environment for operating the user device may be provided, from a second storage in communicative isolation from the first storage, to the user with the display of the user device. Providing the second operating environment may include, with the same operating system of the device, executing second operating environment execution code stored on the second storage. Providing the second operating environment may include providing, on a home screen or desktop of the user device, second applications that, when executed, read and/or write data from and/or to the second storage. Providing the second operating environment may include removing some or all of the first applications from the home screen or desktop of the user device. Because the first and second operating environments are environments of the same user, switching between the first and second (and/or additional) operating environments may be provided without requiring a securing code or password from the user. Because the first and second operating environments are managed by the same operating system, switching between the first and second (and/or additional) operating environments may be provided without requiring any additional boot operations for the switching.

At step 708, second information may be stored using the second storage responsive to the operation of the user device using the second operating environment by the user. Storing the second information may include operating a second application in the second operating environment, generating, receiving, or otherwise acquiring data with the second application, and storing the generated, received, and/or acquired data with the second storage. Some or all of the second information may, in some scenarios, be received via a second network (e.g., using a second SIM card) of the user device. In other scenarios, the second information may be received via the first network (e.g., using the first SIM card). For example, the second information may be received via the first network in scenarios in which the user's home and work networks are the same.

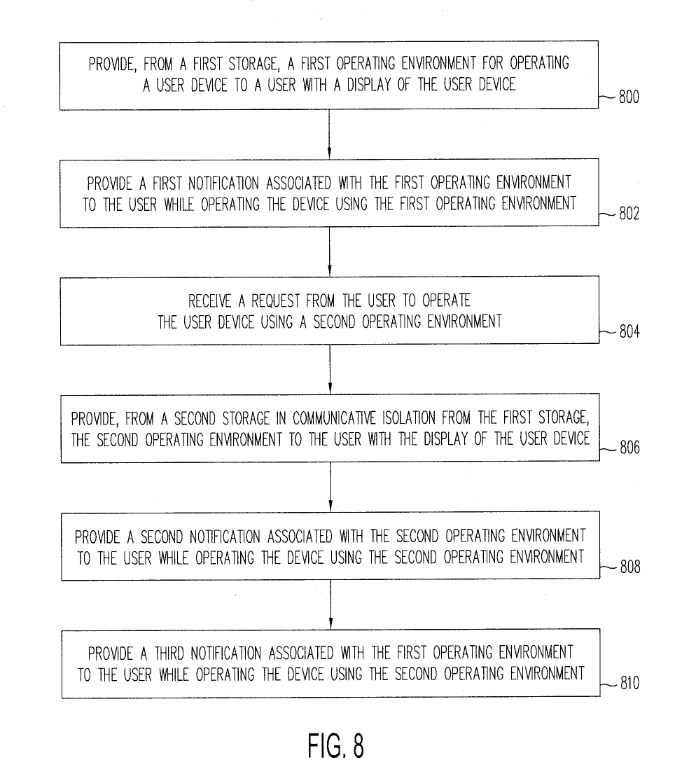

FIG. 8 is a flowchart of an exemplary process for providing notifications to a user with a split user device, according to an embodiment.

At step 800, a first operating environment for operating a user device may be provided, from a first storage, to a user with a display of the user device. Providing the first operating environment may include, with an operating system of the device, executing first operating environment execution code stored on the first storage. Providing the first operating environment may include providing, on a home screen or desktop of the user device, first applications that, when executed, read and/or write data from and/or to the first storage. The first operating environment may, for example, be a personal operating environment for the user.

At step 802, a first notification associated with the first operating environment may be provided to the user while operating the device using the first operating environment. The first notification may, for example, be a calendar notification from the user's personal calendar or a text message (as another example).

At step 804, a request from the user to operate the user device using a second operating environment such as a work operating environment for the user may be received.

At step 806, the second operating environment for operating the user device may be provided, from a second storage in communicative isolation from the first storage, to the user with the display of the user device. Providing the second operating environment may include, with the same operating system of the device, executing second operating environment execution code stored on the second storage. Providing the second operating environment may include providing, on a home screen or desktop of the user device, second applications that, when executed, read and/or write data from and/or to the second storage. Providing the second operating environment may include removing some or all of the first applications from the home screen or desktop of the user device. Because the first and second operating environments are environments of the same user, switching between the first and second (and/or additional) operating environments may be provided without requiring a securing code or password from the user.

At step 808, a second notification associated with the second operating environment may be provided to the user while operating the device using the second operating environment. The second notification may, for example, be a calendar notification from the user's work calendar.

At step 810, a third notification associated with the first operating environment may be provided to the user while operating the device using the second operating environment. The third notification may, for example, be a personal phone call (e.g., from a person listed in the user's personal contacts on the device).

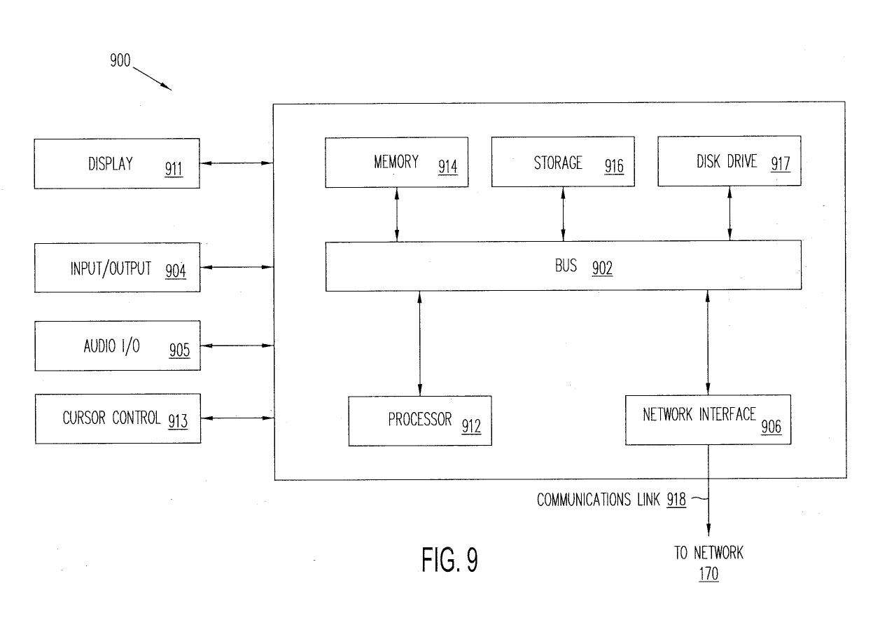

FIG. 9 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. Personal servers and work servers may utilize a network computing device (e.g., a network server) capable of communicating with the network. It should be appreciated that each of the devices utilized by users and service providers may be implemented as computer system 900 in a manner as follows.

Computer system 900 includes a bus 902 or other communication mechanism for communicating information data, signals, and information between various components of computer system 900. Components include an input/output (I/O) component 904 that processes a user action, such as selecting keys from a keypad/keyboard, selecting one or more buttons, image, or links, and/or moving one or more images, etc., and sends a corresponding signal to bus 902. I/O component 904 may also include an output component, such as a display 911 and a cursor control 913 (such as a keyboard, keypad, mouse, etc.). An optional audio input/output component 905 may also be included to allow a user to use voice for inputting information by converting audio signals. Audio I/O component 905 may allow the user to hear audio. A transceiver or network interface 906 transmits and receives signals between computer system 900 and other devices, such as another user device, a merchant device, or a service provider server via network 170. In one embodiment, the transmission is wireless, although other transmission mediums and methods may also be suitable. One or more processors 912, which can each be a micro-controller, digital signal processor (DSP), or other processing component, processes these various signals, such as for display on computer system 900 or transmission to other devices via a communication link 918. Processor(s) 912 may also control transmission of information, such as cookies or IP addresses, to other devices.

Components of computer system 900 also include one or more system memory components such as system memory component 914 (e.g., RAM), one or more static storage components such as static storage component 916 (e.g., ROM), and/or one or more disk drives such as disk drive 917. Computer system 900 performs specific operations by processor(s) 912 and other components by executing one or more sequences of instructions contained in the one or more system memory components 914. Logic may be encoded in one or more computer readable media, which may refer to any medium that participates in providing instructions to processor(s) 912 for execution. Such a medium may take many forms, including but not limited to, non-volatile media, volatile media, and transmission media. In various embodiments, non-volatile media includes optical or magnetic disks, volatile media includes dynamic memory, such as system memory component 914, and transmission media includes coaxial cables, copper wire, and fiber optics, including wires that comprise bus 902. In one embodiment, the logic is encoded in non-transitory computer readable medium. One or more non-transitory computer-readable media may each include instructions which, in response to execution by a computer system, cause the computer system to perform some or all of one or more methods as described herein. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by communication link 918 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above description has been directed to split activities or environments associated with personal (home) and work (business). However, additional or alternative activities and/or environments may also be suitable with other embodiments. In particular, additional work activities and/or environments may be split, such as when a user has two separate employers, either completely distinct or affiliated in some way. In another example, work activities within an employer may be split, such as based on department or work type or security clearance level. In yet another example, a user may want to split personal activities/environments, such as based on type, context, network, etc. In yet another example, a user may want to split a device by various organizations such as social organizations, committees, government organizations, or clubs. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A mobile device comprising:
a first operating environment having a first application;
a first storage;
a second operating environment having a second application;
a second storage; and
an operating system configured to switchably operate the device in the first operating environment or the second operating environment, wherein the first application is configured to read and write data respectively from and to the first storage, wherein the second application is configured to read and write data respectively from and to the second storage, wherein the first application is prevented from reading and writing data respectively from and to the second storage, and wherein the second application is prevented from reading and writing data respectively from and to the first storage.

2. The mobile device of claim 1, further comprising a notification managing engine configured to receive notifications associated with the first and second operating environments and to selectively provide the notifications to a user based on which of the first and second operating environments is being operated and based on one or more notification settings.

3. The mobile device of claim 2, further comprising a housing, wherein the first storage and the second storage are disposed within the housing.

4. The mobile device of claim 3, further comprising a display, wherein the operating system is configured to switchably provide the first operating environment and the second operating environment to a user without performing boot operations.

5. The mobile device of claim 4, wherein, when the operating system operates the mobile device in the first operating environment, the first application is displayed on the display and the second application is not displayed on the display.

6. The mobile device of claim 5, wherein, when the operating system operates the mobile device in the second operating environment, the second application is displayed on the display and the first application is not displayed on the display.

7. The mobile device of claim 6, wherein, when the operating system operates the mobile device in the first or second operating environment, a third application is displayed on the display.

8. The mobile device of claim 1, wherein the first and second storages are partitioned portions of a common storage device.

9. The mobile device of claim 1, wherein the first and second storages are separate storage devices.

10. The mobile device of claim 1, further comprising:
a first SIM port configured to receive a first SIM card of a first network; and
a second SIM port configured to receive a second SIM card of a second network.

11. A method of operating a split mobile device having a display, a first storage, and a second storage, the method comprising:
providing, with an operating system using the first storage, a first operating environment to a user;
while providing the first operating environment to the user, preventing access to the second storage;
receiving, with the operating system, a request from the user to operate the mobile device in a second operating environment;
providing, with the operating system using the second storage, the second operating environment to the user responsive to the receiving; and
while providing the second operating environment to the user, preventing access to the first storage.

12. The method of claim 11, further comprising, while providing the first operating environment to the user, providing a first notification associated with the first operating environment to the user.

13. The method of claim 12, further comprising, while providing the second operating environment to the user, providing a second notification associated with the second operating environment to the user.

14. The method of claim 13, further comprising, while providing the second operating environment to the user, providing a third notification associated with the first operating environment to the user.

15. The method of claim 11, wherein the providing of the second operating system comprises activating the second storage and deactivating the first storage.

16. The method of claim 11, wherein the receiving comprises detecting a swipe on a touchscreen of the mobile device.

17. The method of claim 16, wherein the providing of the second operating system comprises providing access to the second application and preventing access to the first application.

18. A multiple subscriber identity module device, comprising:
a first SIM port configured to receive a first SIM card of a first network;
a second SIM port configured to receive a second SIM card of a second network; and
a coupling mechanism configured to couple the first SIM card and the second SIM card to a SIM port of a mobile device.

19. The multiple subscriber identity module device of claim 18, further comprising the first SIM card in the first SIM port and the second SIM card in the second SIM port.

20. The multiple subscriber identity module device of claim 19, wherein, when the coupling mechanism is disposed in the SIM port of the mobile device, the first SIM card facilitates communications between the mobile device and the first network when the mobile device is operated in a first operating environment and the second SIM card facilitates communications between the mobile device and the second network when the mobile device is operated in a second operating environment.
